(19) United States
(12) Patent Application Publication
(10) Pub. No.: US 2026/0039057 A1
(43) Pub. Date: Feb. 5, 2026

(54) CONNECTOR ASSEMBLY

(71) Applicant: ADVANCED-CONNECTEK INC., New Taipei City (TW)

(72) Inventors: Shu-Fen Wang, New Taipei City (TW); Kuan-Lin Chen, New Taipei City (TW); Hou-Bin Lin, New Taipei City (TW)

(21) Appl. No.: 19/283,759

(22) Filed: Jul. 29, 2025

(30) Foreign Application Priority Data
Aug. 2, 2024 (TW) 113208358

(51) Int. Cl. H01R 13/627; H01R 12/77; H01R 13/506

(52) U.S. Cl. CPC H01R 13/6273; H01R 12/774; H01R 13/506

(57) ABSTRACT

A connector assembly includes a board-end connector and a cable-end connector. The board-end connector includes an outer shell, an insulated housing, and a terminal module. The insulated housing is in the outer shell and has a receiving cavity. Each side of the insulated housing has a groove configured to arrange a corresponding flexible locking portion of the outer shell. The terminal module is in the receiving cavity and includes ground terminals and pairs of signal terminals arranged as a single row along an axial line. The cable-end connector includes a flexible parallel cable and a plug at one end of the flexible parallel cable, and an engaging portion is at each side of the plug. When the plug is inserted into the receiving cavity through an insertion opening of the insulated housing, each of the engaging portions is engaged with a corresponding one of the flexible locking portions.

### CROSS-REFERENCE TO RELATED APPLICATION

This non-provisional application claims priority under 35 U.S.C. § 119(a) to patent application Ser. No. 11/320,8358 filed in Taiwan, R.O.C. on Aug. 2, 2024, the entire contents of which are hereby incorporated by reference.

### FIELD OF THE INVENTION

The instant disclosure relates to a connector, and more particular to a connector assembly.

### BACKGROUND

The connection interfaces in telecommunication industry are developed to be lightweight and tiny and to have stable signal transmissions. For the connection interfaces applied in high speed transmission server and switch, for example, the mini cool edge IO (MCIO) connector, the MCIO connector has a small size plus reliable and stable connection. An MCIO connector known to the inventor includes a board-end connector and a cable-end connector. The cable-end connector comprises a cable, a PCB, and a plug on the PCB. The plug has a plastic core, upper and lower terminals, and a hook member. The board-end connector known to the inventor has a plurality of engaging holes, and the cable-end connector known to the inventor has a plurality of engaging structures in elastic pieces capable of being engaged with the engaging holes. However, the structural configurations of the engaging structures are complicated, and thus the manufacturing cost for the engaging structures is high.

### SUMMARY OF THE INVENTION

In view of these, some embodiments of the instant disclosure provides a connector assembly comprising a board-end connector and a cable-end connector. The board-end connector comprises an outer shell, an insulated housing, and a terminal module. The outer shell comprises a cover plate, and a side plate and a flexible locking portion are at each of two sides of the cover plate. The insulated housing is arranged in the outer shell. The insulated housing has a receiving cavity, and one of two ends of the insulated housing has an insertion opening in communication with the receiving cavity. Each of two sides of the insulated housing has a groove in communication with the receiving cavity, and each of the flexible locking portions is arranged in a corresponding one of the grooves. The terminal module is in the receiving cavity of the insulated housing. The terminal module comprises a plurality of ground terminals and a plurality of pairs of signal terminals arranged as a single row along an axial line. The cable-end connector comprises a flexible parallel cable and a plug at one end of the flexible parallel cable, and an engaging portion is at each of two sides of the plug. When the plug of the cable-end connector is inserted into the receiving cavity through the insertion opening, each of the engaging portions is engaged with a corresponding one of the flexible locking portions.

In some embodiments, each of the flexible locking portions comprises two flexible arms and a buckling portion. Each of the flexible arms of each of the flexible locking portions extends toward the outer shell from the cover plate and extends to the corresponding one of the grooves along a first axial line. The buckling portion of each of the flexible locking portions comprises a guiding arm and at least one protrusion, the guiding arm is at an inner side of the corresponding one of the grooves, the at least one protrusion protrudes from the guiding arm toward the receiving cavity, and for each of the flexible locking portions, two ends of the guiding arm are respectively connected to the flexible arms.

In some embodiments, each of the grooves extends from a top surface of the insulated housing and is in communication with the receiving cavity.

In some embodiments, each of the flexible locking portions comprises a flexible arm and a buckling portion. The flexible arm of each of the flexible locking portions is arranged on a corresponding one of the side plates along a second axial line. The buckling portion of each of the flexible locking portions comprises a guiding arm and a protrusion, the guiding arm is at an inner side of the corresponding one of the grooves, the protrusion protrudes from the guiding arm toward the receiving cavity, and for each of the flexible locking portions, the guiding arm is connected to one of two sides of the flexible arm.

In some embodiments, each of the grooves extends from a side surface at a corresponding one of the two sides of the insulated housing and is in communication with the receiving cavity. Each of the grooves has a first region and a second region, the flexible arm of each of the flexible locking portions is at the first region of the corresponding one of the grooves, and the buckling portion of each of the flexible locking portions is at the second region of the corresponding one of the grooves.

In some embodiments, the first region and the second region of each of the grooves extend from the side surface at the corresponding one of the two sides of the insulated housing and are in communication with the receiving cavity.

In some embodiments, the outer shell has a plurality of bent portions. Each of the flexible locking portions comprises a flexible arm and a buckling portion. The flexible arm of each of the flexible locking portions is arranged on an inner side of a corresponding one of the side plates along a third axial line. The buckling portion of each of the flexible locking portions comprises a guiding arm and a protrusion. The guiding arm is at an inner side of the corresponding one of the grooves, the protrusion protrudes from the guiding arm toward the receiving cavity, the guiding arm is connected to one of two sides of the flexible arm, and each of the bent portions is bent at one end of a corresponding one of the side plates and connected to the other side of a corresponding one of the flexible arms.

In some embodiments, each of the grooves extends from a side surface at a corresponding one of the two sides of the insulated housing and is in communication with the receiving cavity. Each of the grooves has a first region and a second region. A side opening of the first region of each of the grooves is at a side surface of the other end of the insulated housing, the flexible arm of each of the flexible locking portions is at the first region of the corresponding one of the grooves, and the buckling portion of each of the flexible locking portions is at the second region of the corresponding one of the grooves.

In some embodiments, the first region and the second region of each of the grooves extend from the side surface at the corresponding one of the two sides of the insulated housing and are in communication with the receiving cavity.

In some embodiments, the outer shell comprises a frame opening portion. The frame opening portion extends from one end of the cover plate and corresponds to the insertion opening. The insertion opening is between the frame opening portion and the receiving cavity, and the cable connector is configured to be inserted into the receiving cavity through the frame opening portion and the insertion portion.

According to some embodiments of the instant disclosure, the outer shell covers the insulated housing, the grooves are in communication with the receiving cavity, and each of the flexible locking portions is arranged in a corresponding one of the grooves. When the plug of the cable-end connector is inserted into the receiving cavity through the insertion opening, each of the engaging portions is engaged with a corresponding one of the flexible locking portions. Therefore, the cable-end connector and the board-end connector can be properly positioned with each other.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to some embodiments of the instant disclosure, where a board-end connector and a cable-end connector of the connector assembly are not mated with each other yet;

FIG. 2 illustrates a front exploded view of the board-end connector according to some embodiments of the instant disclosure;

FIG. 3 illustrates a rear exploded view of the board-end connector according to some embodiments of the instant disclosure;

FIG. 4 illustrates a partial perspective view of the board-end connector according to some embodiments of the instant disclosure;

FIG. 5 illustrates a partial top cross-sectional view of the connector assembly, where flexible locking portions of the board-end connector are engaging with engaging portions of the cable-end connector;

FIG. 6 illustrates a partial top cross-sectional view of the connector assembly, where the flexible locking portions of the board-end connector are engaged with the engaging portions of the cable-end connector;

FIG. 7 illustrates a partial perspective view of the board-end connector according to some embodiments of the instant disclosure;

FIG. 8 illustrates a top cross-sectional view of the connector assembly according to some embodiments of the instant disclosure;

FIG. 9 illustrates a partial top cross-sectional view of the connector assembly according to some embodiments of the instant disclosure, where the board-end connector and the cable-end connector of the connector assembly are not mated with each other yet;

FIG. 10 illustrates a partial top cross-sectional view of the connector assembly according to some embodiments of the instant disclosure, where the board-end connector and the cable-end connector of the connector assembly are mated with each other;

FIG. 11 illustrates a partial perspective view of the board-end connector according to some embodiments of the instant disclosure;

FIG. 12 illustrates a top cross-sectional view of the connector assembly according to some embodiments of the instant disclosure;

FIG. 13 illustrates a partial top cross-sectional view of the connector assembly according to some embodiments of the instant disclosure, where the board-end connector and the cable-end connector of the connector assembly are not mated with each other yet; and

FIG. 14 illustrates a partial top cross-sectional view of the connector assembly according to some embodiments of the instant disclosure, where the board-end connector and the cable-end connector of the connector assembly are mated with each other.

### DETAILED DESCRIPTION

To illustrate the embodiments of the instant disclosure more clearly, in the drawings, the first axis X is the X axis of the Cartesian coordinate, the second axis Y is the Y axis of the Cartesian coordinate, and the third axis is the Z axis of the Cartesian coordinate.

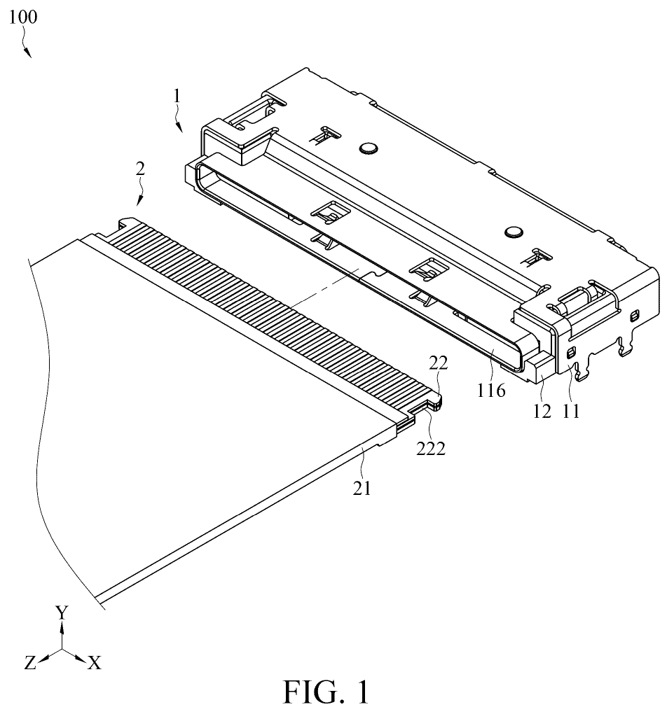

Please refer to FIG. 1. FIG. 1 illustrates a perspective view of a connector assembly 100, where the board-end connector 1 and the cable-end connector 2 of the connector assembly 100 are not mated with each other yet. The signal transmitted by the connector assembly 100 is identical to the signal transmitted by the mini cool edge IO (MCIO) connector, while the structure of the connector assembly 100 is different from the structure of the MCIO connector. The connector assembly 100 comprises a board-end connector 1 and a cable-end connector 2. The board-end connector 1 is an elongated connector. The long side of the board-end connector 1 extends along a first axis X direction, the short side of the board-end connector 1 extends along a third axis Z direction, and the height of the board-end connector 1 extends along a second axis Y direction. The cable-end connector 2 is adapted to be applied for a flexible flat cable (FFC). Because the board-end connector 1 is adapted to be mated with the FFC type cable-end connector 2 which is lightweight and tiny, the size of the board-end connector I can be reduced relatively.

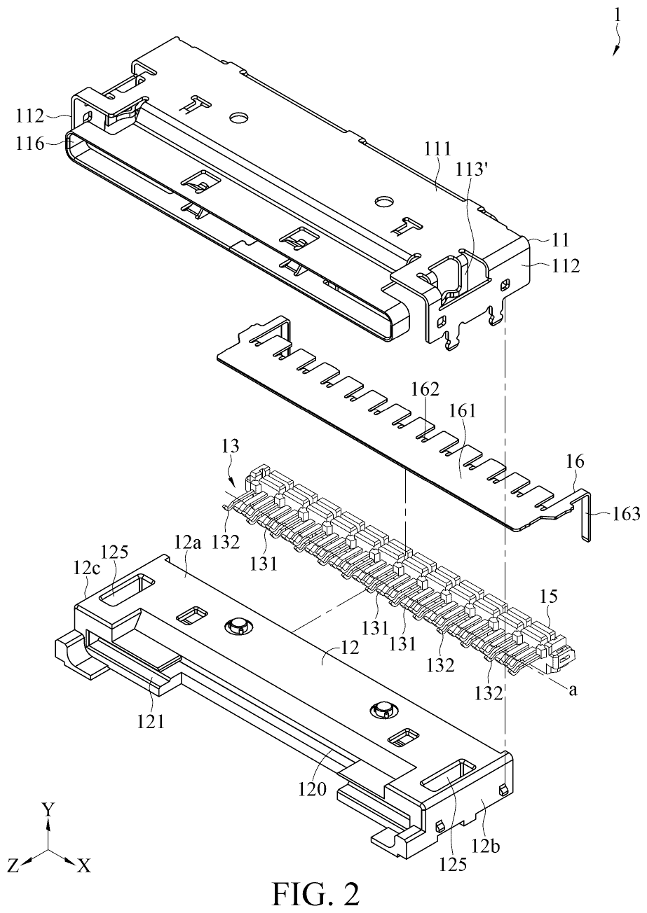

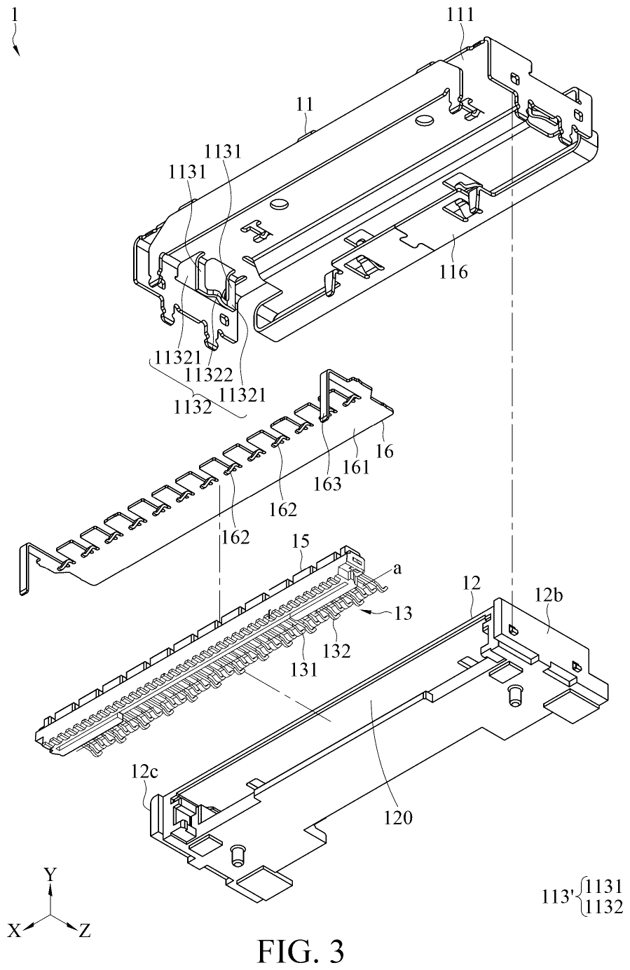

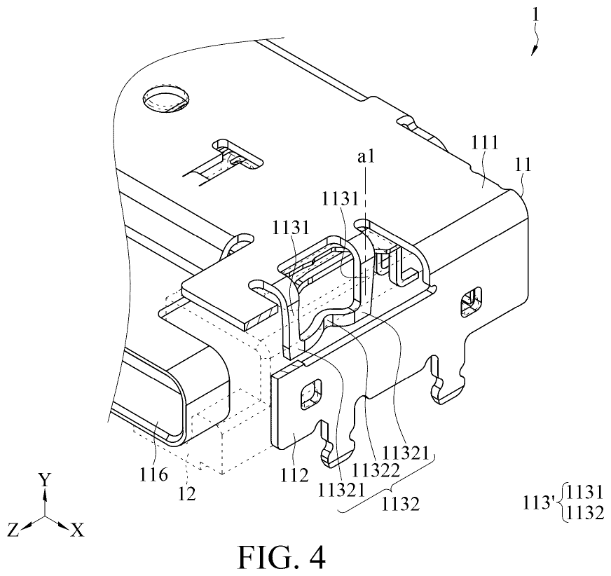

Please refer to FIG. 2 to FIG. 4. FIG. 2 illustrates a front exploded view of the board-end connector 1. FIG. 3 illustrates a rear exploded view of the board-end connector 1. FIG. 4 illustrates a partial schematic view of the flexible locking portion 113′; in FIG. 4, the corner (cross-sectional line region) between the cover plate 111 and the side plate 112 is removed to show the flexible arm 1131, and the insulated housing 12 is illustrated in dash lines. The board-end connector 1 comprises an outer shell 11, an insulated housing 12, and a terminal module 13. The outer shell 11 is a metallic shell, the outer shell 11 comprises a cover plate 111, and a side plate 112 and a flexible locking portion 113′ are at each of two sides of the cover plate 111.

The insulated housing 12 is a hollow rectangular plastic core and in the outer shell 11. The insulated housing 12 has a receiving cavity 120, and one of two ends of the insulated housing 12 has an insertion opening 121 in communication with the receiving cavity 120. Each of two sides of the insulated housing 12 has a groove 125 in communication with the receiving cavity 120. The receiving cavity 120 and the insertion opening 121 are arranged along the third axis Z direction and defined through the insulated housing 12, and the insertion opening 121 is a long and narrow opening extending along the first axis X direction. In some embodiments, the outer shell 11 comprises a frame opening portion 116, the frame opening portion 116 is a long and narrow opening extending along the first axis X direction, the frame opening portion 116 extends from one end of the cover plate 111 and corresponds to the insertion opening 121, and the insertion opening 121 is between the frame opening portion 116 and the receiving cavity 120.

The terminal module 13 is in the receiving cavity 120 of the insulated housing 12, and the terminal module 13 comprises a plurality of ground terminals 131 and a plurality of pairs of signal terminals 132 arranged as a single row along an axial line a.

The cable-end connector 2 comprises a flexible parallel cable 21 and a plug 22 at one end of the flexible parallel cable 21. An engaging portion 222 is at each of two sides of the plug 22. In some embodiments, the flexible parallel cable 21 is a flexible flat cable (FFC), the length of the flexible parallel cable 21 is not limited, the plug 22 is an elongated plate, and two plugs 22 are at two ends of the flexible parallel cable 21, respectively.

When the cable-end connector 2 is inserted into the receiving cavity 120 of the board-end connector 1 through the frame opening portion 116 and the insertion opening 121, the plug 22 of the cable-end connector 2 is inserted into the receiving cavity 120 through the insertion opening 121, and each of the engaging portions 222 is engaged with a corresponding one of the flexible locking portions 113′. Specifically, in some embodiments, the grooves 125 are in communication with the receiving cavity 120 of the insulated housing 12, and the flexible locking portions 113′ are in the grooves 125. Therefore, when the cable-end connector 2 is mated with the board-end connector 1, the plug 22 of the cable-end connector 2 is inserted into the receiving cavity 120 and the grooves 125 through the insertion opening 121, and the engaging portions 222 are engaged with the flexible locking portions 113′ which are respectively in the grooves 125.

Please refer to FIG. 2 and FIG. 4. In some embodiments, the flexible locking portion 113′ comprises two flexible arms 1131 and a buckling portion 1132. Each of the flexible arms 1131 of each of the flexible locking portions 113′ extends toward the outer shell 11 from the cover plate 11 and extends to the corresponding one of the grooves 125 along a first axial line al, where the first axial line al is identical to the second axis Y direction. The buckling portion 1132 of each of the flexible locking portions 113′ comprises a guiding arm 11321 and at least one protrusion 11322. For each of the flexible locking portions 113′, the guiding arm 11321 is at an inner side of the corresponding one of the grooves 125, the at least one protrusion 11322 protrudes from the guiding arm 11321 toward the receiving cavity 120, and two ends of the guiding arm 11321 are respectively connected to the two flexible arms 1131. That is, in some embodiments, the flexible locking portion 113′ has the two flexible arms 1131 extending from the cover plate 111 along the second axis Y direction, and the two flexible arms 1131 are respectively connected to the buckling portion 1132; a length of the flexible arm 1131 (the lever arm of the flexible arm 1131) extends from the cover plate 111 to the connection portion between the buckling portion 1132 and the flexible arm 1131 along the second axis Y direction, the buckling portion 1132 has the guiding arm 1132 perpendicular to the two flexible arms 1131, and the guiding arm 11321 has the protrusion 11322.

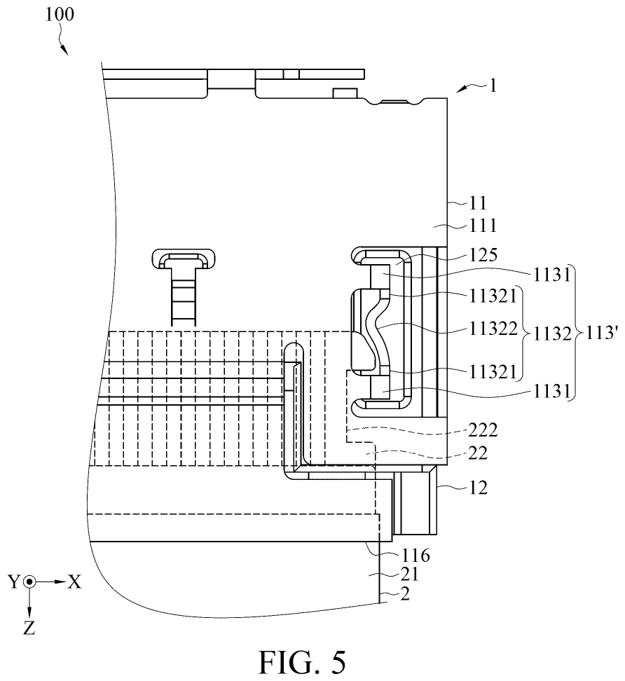

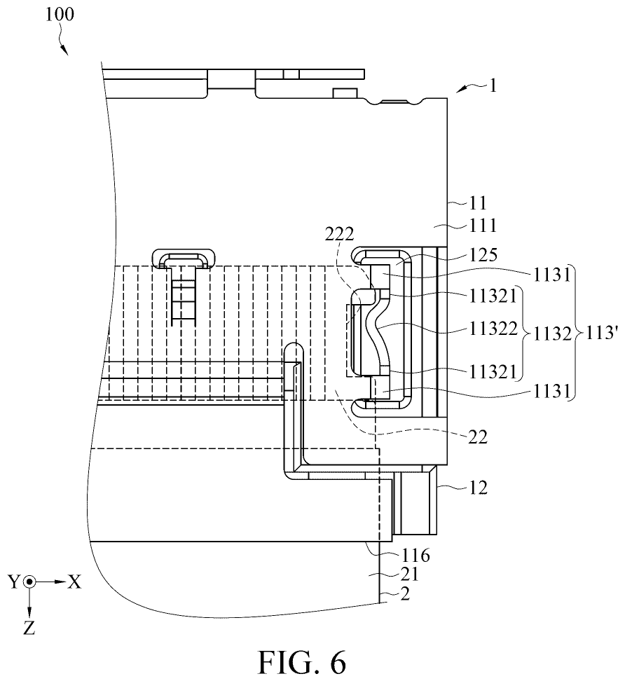

Please refer to FIG. 5 and FIG. 6. FIG. 5 illustrates a partial top cross-sectional view

of the connector assembly 100, where the flexible locking portions 113′ of the board-end connector 1 are engaging with the engaging portions 222 of the cable-end connector 2. FIG. 6 illustrates a partial top cross-sectional view of the connector assembly 100, where the flexible locking portions 113′ of the board-end connector 1 are engaged with the engaging portions 222 of the cable-end connector 2. In FIG. 5 and FIG. 6, the cable-end connector 2 is illustrated in dashed lines. In some embodiments, the grooves 125 are recessed from the top surface 12a of the insulated housing 12 (as shown in FIG. 2) along the second axis Y direction and in communication with the receiving cavity 120, and the flexible locking portions 113′ are arranged in the grooves 125 and adjacent to the receiving cavity 120. When the plug 22 is inserting into the insertion opening 121 to be mated with the flexible locking portions 113′, the plug 22 is moved to the receiving cavity 120 along the third axis Z direction, and the plug 22 pushes the guiding arm 11321 and the protrusion 11322 to drive the flexible arms 1131 to swing. Therefore, the flexible arm 1131 takes one end of the flexible arm 1131 adjacent to the cover plate 111 as a fulcrum to swing, so that the guiding arm 11321 pops up from the side plate 112 along the first axis X direction. Next, when the plug 22 is inserting into the inner side of the receiving cavity 120, the engaging portion 222 is engaged with the protrusion 11322, and the flexible arm 1131 is moved resiliently using the resilient force.

Please refer to FIG. 2. In some embodiments, the connector assembly 100 further comprises a conductive body 16 for grounding and noise conduction. The conductive body 16 comprises a main body 161 and a plurality of extension portions 162. The main body 161 is a rectangular plate extending along the first axis X direction, each of the extension portions 162 is an inclined arm, and each of the extension portions 162 outward extends from a rear portion of the main body 161. When the main body 161 is assembled in the receiving cavity 120, the main body 161 is in the receiving cavity 120 and on the terminal base 15, and each of the extension portions 162 is connected to a first body portion of a corresponding one of the ground terminals 132. The conductive body 16 further comprises a plurality of legs 163 outward extending from two sides of the main body 161 along the same direction, and the legs 163 are adapted to be connected to a printed circuit board for grounding and noise conduction.

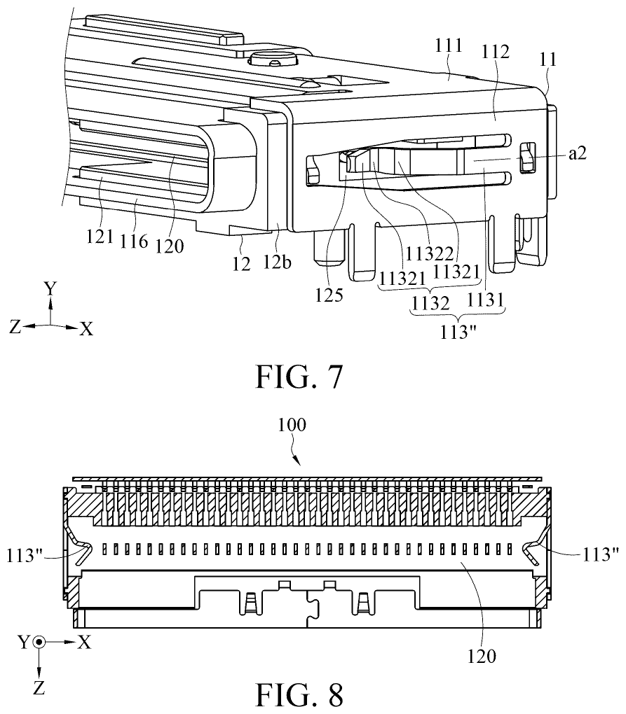

Please refer to FIG. 7 and FIG. 8. FIG. 7 illustrates a partial perspective view of the board-end connector 1. FIG. 8 illustrates a top cross-sectional view of the connector assembly 100. In some embodiments, each of the flexible locking portions 113″ comprises a flexible arm 1131 and a buckling portion 1132. The flexible arm 1131 of each of the flexible locking portions 113″ is arranged on a corresponding one of the side plates 112 along a second axial line a2, where the second axial line a2 is identical to the third axis Z direction. The buckling portion 1132 of each of the flexible locking portions 113″ comprises a guiding arm 11321 and a protrusion 11322. For each of the flexible locking portions 113″, the guiding arm 11321 is at an inner side of the corresponding one of the grooves 125, the protrusion 11322 protrudes from the guiding arm 11321 toward the receiving cavity 120, and the guiding arm 11321 is connected to one of two sides of the flexible arm 1131. In other words, in some embodiments, the flexible locking portion 113″ has the flexible arm 1131 extending from the cover plate 111 along the third axis Z direction, and for each of the flexible locking portions 113″, one end of the flexible arm 1131 extends from the edge of the hole at the corresponding one of the side plates 112 and is connected to the buckling portion 1132; the buckling portion 1132 has the guiding arm 11321 and the protrusion 11322. For each of the flexible locking portions 113′, one end of the flexible arm 1131 is connected to the guiding arm 11321, and a length of the flexible arm 1131 (the lever arm of the flexible arm 1131) equal to the distance between the edge of the hole at the side plate 112 and the guiding arm 11321.

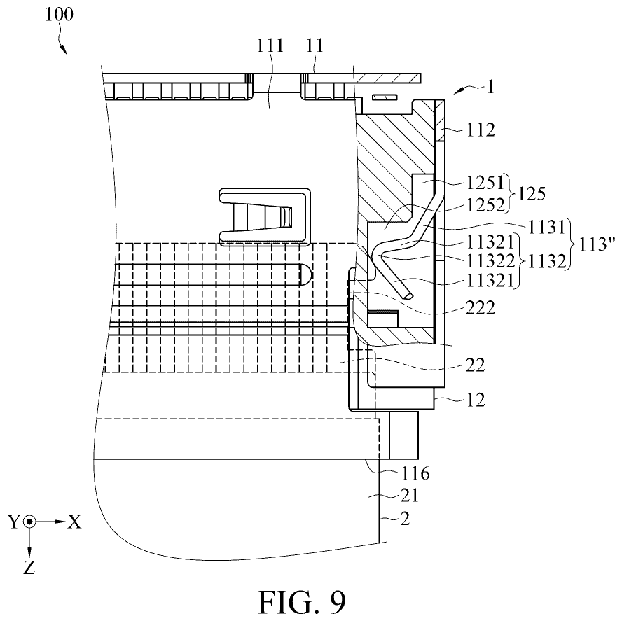

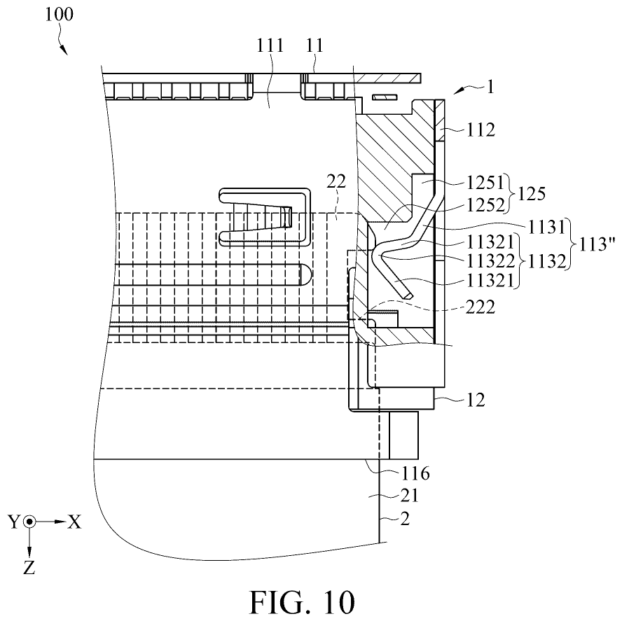

Please refer to FIG. 9 and FIG. 10. FIG. 9 illustrates a partial top cross-sectional view of the connector assembly 100, where the board-end connector 1 and the cable-end connector 2 of the connector assembly 100 are not mated with each other yet. FIG. 10 illustrates a partial top cross-sectional view of the connector assembly 100, where the board-end connector 1 and the cable-end connector 2 of the connector assembly 100 are mated with each other. In FIG. 9 and FIG. 10, the cable-end connector 2 is illustrated in dashed lines. In some embodiments, the grooves 125 are recessed from the two side surfaces (as the side surface 12b and the side surface 12c shown in FIG. 2) of the insulated housing 12 along the first axis X direction and in communication with the receiving cavity 120, and the flexible locking portions 113″ are arranged in the grooves 125. The groove 125 is divided into a first region 1251 and a second region 1252 corresponding to the flexible locking portion 113″. The first region 1251 and the second region 1252 of each of the grooves 125 respectively extend from the two side surfaces (as the side surface 12b and the side surface 12c shown in FIG. 2) of the insulated housing 12 and are in communication with the receiving cavity 120. A side opening of the first region 1251 of each of the grooves is at a side surface of the other end of the insulated housing 12. The first region 1251 is a region with a movement path allowing the flexible arm 1131 to be moved toward the receiving cavity 120; the second region 1252 is a rectangular space, and the second region 1252 is a region with a movement path allowing the buckling portion 1132 to be moved toward the receiving cavity 120. Viewing the insulated housing 12 along the second axis Y direction (top view) shown in FIG. 9, the groove 125 is formed as a mirrored L-shaped space, where the space of the first region 1251 is small than the space of the second region 1252. When the plug 22 is inserted into the insertion opening 121 to be mated with the flexible locking portions 113″, the plug 22 is moved to the receiving cavity 120 along the third axis Z direction, and the plug 22 contacts the guiding arm 11321 and the protrusion 11322 to drive the flexible arms 1131 to swing. Therefore, the flexible arm 1131 takes one end of the flexible arm 1131 adjacent to the side plate 112 as a fulcrum to swing, so that the guiding arm 11321 pops up from the side plate 112 along the first axis X direction. Next, when the plug 22 is inserting into the inner side of the receiving cavity 120, the engaging portion 222 is engaged with the protrusion 11322, and the flexible arm 1131 is moved resiliently using the resilient force.

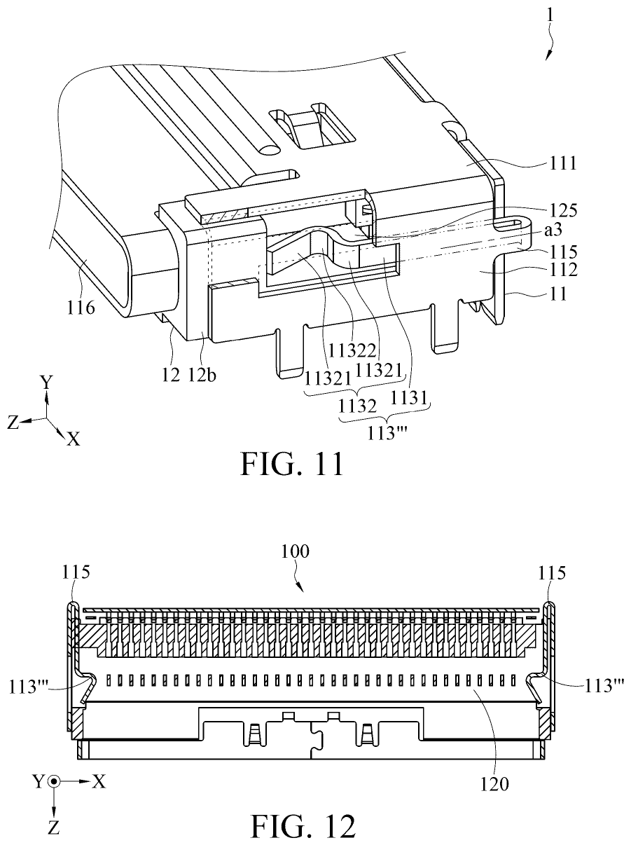

Please refer to FIG. 11 and FIG. 12. FIG. 11 illustrates a partial perspective view of the board-end connector 1; in FIG. 11, the corner (cross-sectional line region) between the cover plate 111 and the side plate 112 is removed to show the flexible arm 1131, and the insulated housing 12 is illustrated in two-dot chain lines. FIG. 12 illustrates a top cross-sectional view of the connector assembly 100. In some embodiments, the outer shell 11 has a plurality of bent portions 115, and each of the flexible locking portions 113″′ comprises a flexible arm 1131 and a buckling portion 1132. The flexible arm 1131 of each of the flexible locking portions 113″′ is arranged on an inner side of a corresponding one of the side plates 112 along a third axial line a3, where the third axial line a3 is identical to the third axis Z direction. The buckling portion 1132 of each of the flexible locking portions 113″′ comprises a guiding arm 11321 and a protrusion 11322. For each of the flexible locking portions 113′′, the guiding arm 11321 is at an inner side of the corresponding one of the grooves 125, the protrusion 11322 protrudes from the guiding arm 11321 toward the receiving cavity 120, the guiding arm 11321 is connected to tone of two sides of the flexible arm 1131, and each of the bent portions 115 is bent at one end of a corresponding one of the side plates 112 and connected to the other side of a corresponding one of the flexible arms 1131. In other words, in some embodiments, each of the flexible locking portions 113″′ is bent from the inner side of the corresponding one of the side plates 112 toward the receiving cavity 120. One end of each of the flexible arms 1131 extends from the corresponding one of the bent portions 115 toward the interior of the outer shell 11 and is parallel to the corresponding one of the side plates 112. The flexible arms 1131 extend along the third axis Z direction and arranged on the inner sides of the side plates 112 in a side-by-side manner. The buckling portion 1132 comprises a guiding arm 11321 and a protrusion 11322, one end of the flexible arm 1131 is connected to the guiding arm 11321, and a length of the flexible arm 1131 (the lever arm of the flexible arm 1131) equal to the distance between the bent portion 115 and the guiding arm 11321.

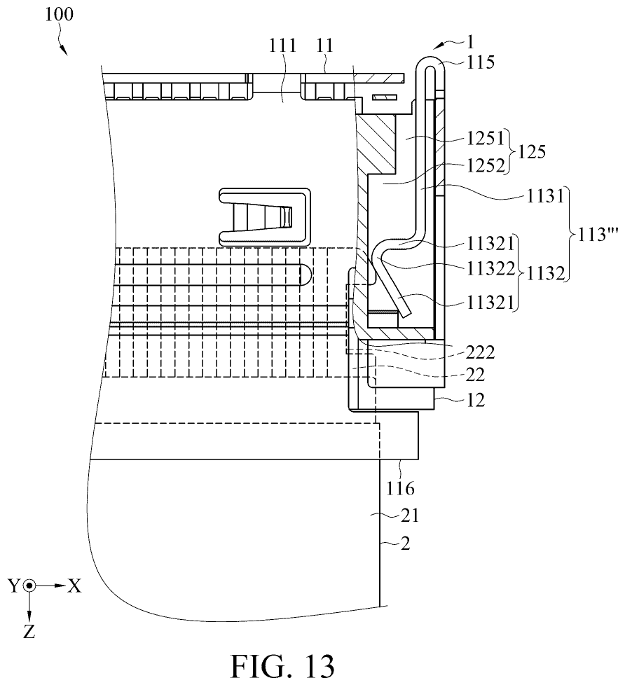

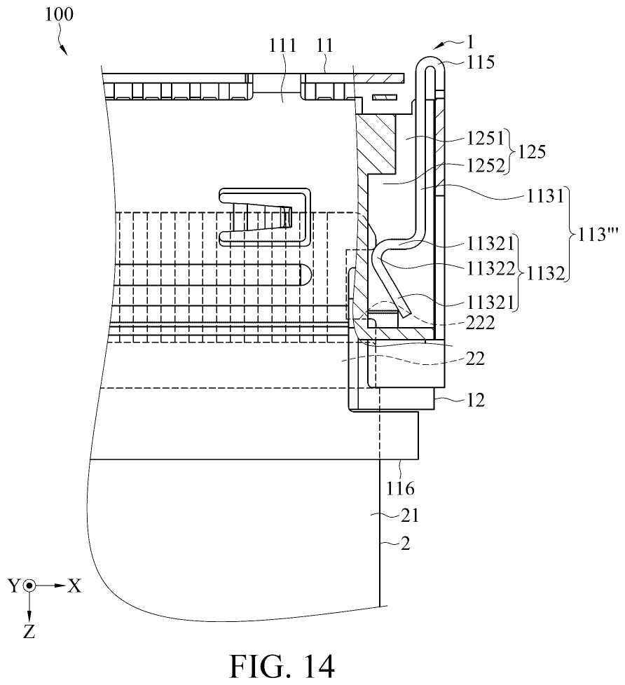

Please refer to FIG. 13 and FIG. 14. FIG. 13 illustrates a partial top cross-sectional view of the connector assembly 100, where the board-end connector 1 and the cable-end connector 2 of the connector assembly 100 are not mated with each other yet. FIG. 14 illustrates a partial top cross-sectional view of the connector assembly 100, where the board-end connector 1 and the cable-end connector 2 of the connector assembly 100 are mated with each other. In some embodiments, the grooves 125 are recessed from the two side surfaces (as the side surface 12b and the side surface 12c shown in FIG. 2) of the insulated housing 12 along the first axis X direction and in communication with the receiving cavity 120, and the flexible locking portions 113″′ are arranged in the grooves 125. The groove 125 is divided into a first region 1251 and a second region 1252 corresponding to the flexible locking portion 113″′. The first region 1251 and the second region 1252 of each of the grooves 125 respectively extend from the two side surfaces (as the side surface 12b and the side surface 12c shown in FIG. 2) of the insulated housing 12 and are in communication with the receiving cavity 120. The first region 1251 is in communication with a rear side surface of the insulated housing 12 away from the insertion opening 121, and the first region 1251 is a region with a movement path allowing the flexible arm 1131 to be moved toward the receiving cavity 120; the second region 1252 is a rectangular space, and the second region 1252 is a region with a movement path allowing the buckling portion 1132 to be moved toward the receiving cavity 120. Viewing the insulated housing 12 along the second axis Y direction (top view) shown in FIG. 13, the groove 125 is formed as a mirrored L-shaped space, where the space of the first region 1251 is small than the space of the second region 1252. When the plug 22 is inserted into the insertion opening 121 to be mated with the flexible locking portions 113″′, the plug 22 is moved to the receiving cavity 120 along the third axis Z direction, and the plug 22 contacts the guiding arm 11321 and the protrusion 11322 to drive the flexible arms 1131 to swing. Therefore, the flexible arm 1131 takes the bent portion 115 as a fulcrum to swing, so that the guiding arm 11321 pops up from the side plate 112 along the first axis X direction. Next, when the plug 22 is inserting into the inner side of the receiving cavity 120, the engaging portion 222 is engaged with the protrusion 11322, and the flexible arm 1131 is moved resiliently using the resilient force.

According to some embodiments of the instant disclosure, the outer shell covers the insulated housing, the grooves are in communication with the receiving cavity, and each of the flexible locking portions is arranged in a corresponding one of the grooves. When the plug of the cable-end connector is inserted into the receiving cavity through the insertion opening, each of the engaging portions is engaged with a corresponding one of the flexible locking portions. Therefore, the cable-end connector and the board-end connector can be properly positioned with each other.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A connector assembly, comprising:
a board-end connector comprising:
an outer shell comprising a cover plate, wherein a side plate and a flexible locking portion are at each of two sides of the cover plate;
an insulated housing arranged in the outer shell, wherein the insulated housing has a receiving cavity, one of two ends of the insulated housing has an insertion opening in communication with the receiving cavity, each of two sides of the insulated housing has a groove in communication with the receiving cavity, and each of the flexible locking portions is arranged in a corresponding one of the grooves; and
a terminal module in the receiving cavity of the insulated housing, wherein the terminal module comprises a plurality of ground terminals and a plurality of pairs of signal terminals arranged as a single row along an axial line; and
a cable-end connector comprising a flexible parallel cable and a plug at one end of the flexible parallel cable, wherein an engaging portion is at each of two sides of the plug;
wherein when the plug of the cable-end connector is inserted into the receiving cavity through the insertion opening, each of the engaging portions is engaged with a corresponding one of the flexible locking portions.

2. The connector assembly according to claim 1, wherein each of the flexible locking portions comprises two flexible arms and a buckling portion, each of the flexible arms of each of the flexible locking portions extends toward the outer shell from the cover plate and extends to the corresponding one of the grooves along a first axial line, the buckling portion of each of the flexible locking portions comprises a guiding arm and at least one protrusion; for each of the flexible locking portions, the guiding arm is at an inner side of the corresponding one of the grooves, the at least one protrusion protrudes from the guiding arm toward the receiving cavity, and two ends of the guiding arm are respectively connected to the two flexible arms.

3. The connector assembly according to claim 2, wherein each of the grooves extends from a top surface of the insulated housing and is in communication with the receiving cavity.

4. The connector assembly according to claim 1, wherein each of the flexible locking portions comprises a flexible arm and a buckling portion, the flexible arm of each of the flexible locking portions is arranged on a corresponding one of the side plates along a second axial line, the buckling portion of each of the flexible locking portions comprises a guiding arm and a protrusion; for each of the flexible locking portions, the guiding arm is at an inner side of the corresponding one of the grooves, the protrusion protrudes from the guiding arm toward the receiving cavity, and the guiding arm is connected to one of two sides of the flexible arm.

5. The connector assembly according to claim 4, wherein each of the grooves extends from a side surface at a corresponding one of the two sides of the insulated housing and is in communication with the receiving cavity, each of the grooves has a first region and a second region, the flexible arm of each of the flexible locking portions is at the first region of the corresponding one of the grooves, and the buckling portion of each of the flexible locking portions is at the second region of the corresponding one of the grooves.

6. The connector assembly according to claim 5, wherein the first region and the second region of each of the grooves extend from the side surface at the corresponding one of the two sides of the insulated housing and are in communication with the receiving cavity.

7. The connector assembly according to claim 1, wherein the outer shell has a plurality of bent portions, each of the flexible locking portions comprises a flexible arm and a buckling portion, the flexible arm of each of the flexible locking portions is arranged on an inner side of a corresponding one of the side plates along a third axial line, the buckling portion of each of the flexible locking portions comprises a guiding arm and a protrusion, the guiding arm is at an inner side of the corresponding one of the grooves, the protrusion protrudes from the guiding arm toward the receiving cavity, the guiding arm is connected to one of two sides of the flexible arm, and each of the bent portions is bent at one end of a corresponding one of the side plates and connected to the other side of a corresponding one of the flexible arms.

8. The connector assembly according to claim 7, wherein each of the grooves extends from a side surface at a corresponding one of the two sides of the insulated housing and is in communication with the receiving cavity, each of the grooves has a first region and a second region, a side opening of the first region of each of the grooves is at a side surface of the other end of the insulated housing, the flexible arm of each of the flexible locking portions is at the first region of the corresponding one of the grooves, and the buckling portion of each of the flexible locking portions is at the second region of the corresponding one of the grooves.

9. The connector assembly according to claim 8, wherein the first region and the second region of each of the grooves extend from the side surface at the corresponding one of the two sides of the insulated housing and are in communication with the receiving cavity.

10. The connector assembly according to claim 1, wherein the outer shell comprises a frame opening portion, the frame opening portion extends from one end of the cover plate and corresponds to the insertion opening, the insertion opening is between the frame opening portion and the receiving cavity, and the cable connector is configured to be inserted into the receiving cavity through the frame opening portion and the insertion opening.
